(19) United States
(12) Patent Application Publication
(10) Pub. No.: US 2022/0379322 A1
(43) Pub. Date: Dec. 1, 2022

(54) SHOWERHEAD

(71) Applicant: Nanchang Kohler Ltd., Nanchang (CN)

(72) Inventors: Pengcheng He, Nanchang (CN); Shenghe Chen, Nanchang (CN)

(73) Assignee: Nanchang Kohler Ltd., Nanchang (CN)

(21) Appl. No.: 17/726,102

(22) Filed: Apr. 21, 2022

(30) Foreign Application Priority Data
May 20, 2021 (CN) 202121092858.7

(51) Int. Cl. B05B 1/30; B05B 1/18

(52) U.S. Cl. CPC B05B 1/3006; B05B 1/18

(57) ABSTRACT

The present disclosure relates to a showerhead including an upper cover, a lower cover, and a middle plate disposed between the upper cover and the lower cover. A bottom portion of the middle plate defines a first water cavity and a second water cavity that is independent from the first water cavity. The middle plate further defines a first water inlet channel in fluid communication with the first water cavity and a second water inlet channel in fluid communication with the second water cavity. The lower cover includes a first water outlet in fluid communication with the first water cavity and a second water outlet in fluid communication with the second water cavity. The second water inlet channel includes a plug that can open and/or close the second water inlet channel responsive to water pressure exerted on the plug within the showerhead.

### CROSS-REFERENCE TO RELATED PATENT APPLICATION

This application claims the benefit of and priority to Chinese Patent Application No. 202121092858.7, filed May 20, 2021, the entire disclosure of which is incorporated by reference herein.

### BACKGROUND

In the sanitary industry, showerheads are becoming larger to accommodate customer requirements for a particular shower experience. However, increasing the size of a showerhead can lead to a low water pressure expelling from the showerhead, which can result in an unsatisfactory shower experience.

The present disclosure relates generally to shower devices, and more particularly, to a showerhead capable of switching flow paths depending on water pressure to maintain a satisfactory water pressure expelled from the showerhead.

### SUMMARY

At least one embodiment of the present disclosure is directed towards a showerhead that includes an upper cover, a lower cover, and a middle plate disposed between the upper cover and the lower cover. A bottom portion of the middle plate defines a first water cavity and a second water cavity that is independent from the first water cavity. The middle plate further defines a first water inlet channel in fluid communication with the first water cavity and a second water inlet channel in fluid communication with the second water cavity. The lower cover includes a first water outlet in fluid communication with the first water cavity and a second water outlet in fluid communication with the second water cavity. The second water inlet channel includes a plug that can open and close the second water inlet channel responsive to water pressure exerted on the plug within the showerhead.

At least one embodiment of the present disclosure is directed towards a method. The method includes providing a showerhead. The showerhead includes an upper cover, a lower cover, and a middle plate disposed between the upper cover and the lower cover. A bottom portion of the middle plate defines a first water cavity and a second water cavity that is independent from the first water cavity. The middle plate further defines a first water inlet channel in fluid communication with the first water cavity and a second water inlet channel in fluid communication with the second water cavity. The lower cover includes a first water outlet in fluid communication with the first water cavity and a second water outlet in fluid communication with the second water cavity. The second water inlet channel includes a plug that can open and close the second water inlet channel responsive to water pressure exerted on the plug within the showerhead.

In some embodiments, when the plug closes the second water inlet channel, water is that can discharge from the first water outlet and, when the plug opens the second water inlet channel, water is that can discharge from both the first water outlet and the second water outlet.

In some embodiments, the showerhead includes a bracket disposed in the second water inlet channel. The bracket includes a water inlet. The plug is slidably configured in the second water inlet channel. When the plug is in an initial state, the plug is engaged with the bracket and blocks the water inlet. When the plug is in an open state, the plug is separated from the bracket and withdrawn from the water inlet. The plug is coupled to a reset mechanism that can bias the plug towards the initial state.

In some embodiments, the reset mechanism includes a first magnet coupled to the bracket and a second magnet coupled to the plug. The second magnet can attract the first magnet.

In some embodiments, wherein the first magnet and the second magnet are both annular.

In some embodiments, the reset mechanism includes a spring coupled to the plug and that can bias the plug towards the initial state.

In some embodiments, when the water pressure exerted on the plug is greater than or equal to a threshold pressure value, the plug can slide to open the water inlet. When the water pressure exerted on the plug is less than the threshold pressure value, the plug is can slide to block the water inlet via the reset mechanism.

In some embodiments, the plug includes a sliding rod. The bracket includes a guide hole to receive the sliding rod.

In some embodiments, a diameter of the guide hole is greater than or equal to a diameter of the sliding rod.

In some embodiments, the second water cavity is located outside the first water cavity along a radial direction of the middle plate.

In some embodiments, the first water inlet channel is located outside the second water inlet channel along a radial direction of the middle plate.

In some embodiments, the first water outlet is located outside the second water outlet along a radial direction of the middle plate.

In some embodiments, the second water inlet channel is fluidly coupled to the second water cavity by a communication channel.

In some embodiments, the middle plate includes two first water cavities symmetrically positioned on the middle plate. The second water cavity surrounds the outside of the two first water cavities.

In some embodiments, the plug includes a radial seal.

In some embodiments, the second water inlet channel includes a radial seal.

In some embodiments, the lower cover includes a plurality of first water outlets in fluid communication with the first water cavity and a plurality of second water outlets in fluid communication with the second water cavity.

In some embodiments, an amount of the plurality of first water outlets is less than an amount of the plurality of second water outlets.

In some embodiments, the middle plate includes a separating rib between the first water cavity and the second water cavity.

### BRIEF DESCRIPTION OF THE DRAWINGS

FIG. 1 is a rear perspective view of a showerhead, according to an exemplary embodiment.

FIG. 2 is a cross-sectional view of the showerhead of FIG. 1 at a closed position, according to an exemplary embodiment.

FIG. 3 is a cross-sectional view of the showerhead of FIG. 1 at an open position, according to an exemplary embodiment.

FIG. 4 is an enlarged view of a portion of the showerhead of FIG. 2, according to an exemplary embodiment.

FIG. 5 is an enlarged view of a portion of the showerhead of FIG. 3, according to an exemplary embodiment.

FIG. 6 is a cross-sectional view of a middle plate of the showerhead of FIG. 1, according to an exemplary embodiment.

FIG. 7 is an enlarged view of a portion of the middle plate of FIG. 6, according to an exemplary embodiment.

FIG. 8 is a rear view of the middle plate of FIG. 6, according to an exemplary embodiment.

FIG. 9 is a front view of the middle plate of FIG. 6, according to an exemplary embodiment.

FIG. 10 is a rear perspective view of a lower cover of the showerhead of FIG. 1, according to an exemplary embodiment.

FIG. 11 is an exploded view of a reset mechanism and a plug of the showerhead of FIG. 1, according to an exemplary embodiment.

### DETAILED DESCRIPTION

Referring generally to the FIGURES, provided herein are showerheads that are configured to select one or more different water outlets responsive to a particular water pressure. The showerhead includes a first water inlet channel in fluid communication with a first set of outlets and a second water inlet channel in fluid communication with a second set of outlets. The showerhead includes a stopper (e.g., a plug) that is biased to a position in which the second water inlet channel is closed such that water only flows through the first water inlet channel and out of the first set of outlets. When the water pressure in the showerhead exceeds a threshold pressure, the pressure of water causes the stopper to move such that water flows through both the first water inlet channel and the second water inlet channel and out of each of the first set of outlets and the second set of outlets, which facilitates increasing an impact force and a range of water sprayed to improve shower experience. When the water pressure is low (e.g., at or below the threshold pressure), the stopper biases to close the second water inlet channel, and water is sprayed only out of the first set of outlets, which increases an impact force of water as opposed to spraying out of both sets of outlets.

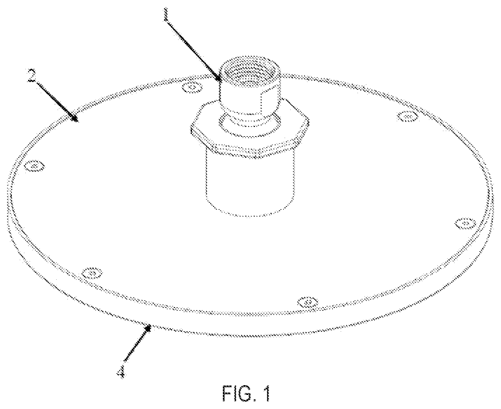

Referring to FIGS. 1-3, a showerhead according to an exemplary embodiment includes an upper cover 2, a lower cover 4, and a middle plate 3 disposed between the upper cover 2 and the lower cover 4. The lower cover 4 is coupled to the upper cover 2 (e.g., via fasteners, welding, and/or adhesives) such that a cavity is formed between the lower cover 4 and the upper cover 2, and the middle plate 3 is disposed within the cavity between the lower cover 4 and the upper cover 2. The upper cover 2 (e.g., a rear surface of the showerhead) includes at least one inlet 1 that is capable of receiving water from a water source (e.g., a municipal water supply) and the lower cover 4 includes a plurality of outlets that are capable of expelling water received from the inlet 1. The middle plate 3 includes one or more fluid flow channels to direct water from the inlet 1 to the outlets of the lower cover 4. As such, water can enter the showerhead through the inlet 1 and can pass through the one or more flow channels in the middle plate 3 to be sprayed out through water outlets in the lower cover 4.

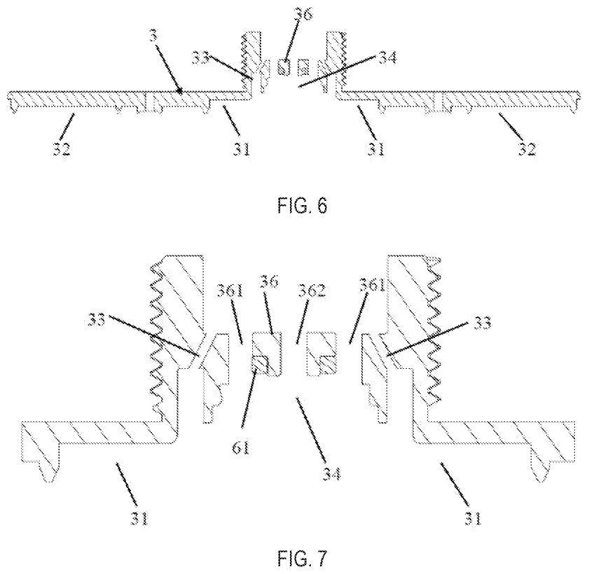

Referring to FIGS. 6, 7, and 9, a bottom portion of the middle plate 3 defines a first water cavity 31 and a second water cavity 32. In some exemplary embodiments, the first water cavity 31 and the second water cavity 32 can be independent of each other, such that water within the first water cavity 31 does not mix or combine with water in the second water cavity 32. For example, the first water cavity 31 and the second water cavity 32 can be separated by a separating rib 38 (e.g., one or more extensions, protrusions, grooves, or other features that separate the first water cavity 31 and the second water cavity 32 such that water within each cavity does not mix). In some exemplary embodiments, the first water cavity 31 can fluidly couple to the second water cavity 32.

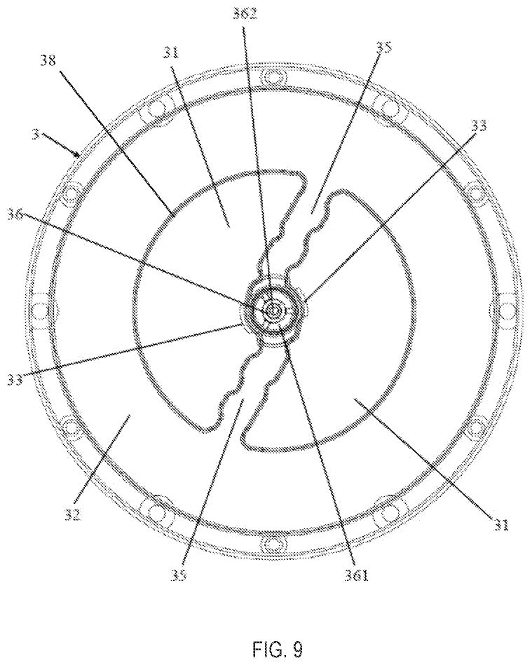

In some exemplary embodiments, the showerhead includes two first water cavities 31. For example, the two first water cavities 31 can be disposed symmetrically about the inlet 1 in a radial direction of the showerhead, as shown in FIG. 9. In these embodiments, the second water cavity 32 can at least partially surround an outer portion of the first water cavities 31 in a radial direction of the showerhead such that the second water cavity 32 is positioned further from the inlet 1 than the first water cavities 31.

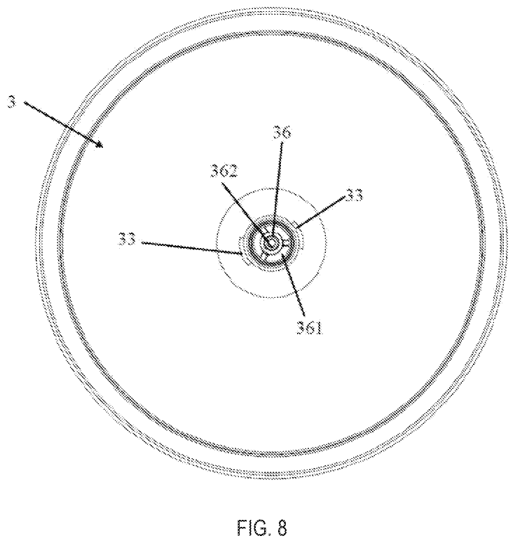

As shown in FIGS. 6-9, the middle plate 3 includes a first water inlet channel 33 and a second water inlet channel 34. Each of the first water inlet channel 33 and the second water inlet channel 34 can receive water from the inlet 1 (e.g., each channel is in fluid communication with the inlet 1). The first water inlet channel 33 can fluidly couple to the first water cavity 31 such that the first water inlet channel 33 is in fluid communication with the first water cavity 31 for supplying water from the inlet 1 to the first water cavity 31. The second water inlet channel 34 can fluidly couple to the second water cavity 32 such that the second water inlet channel 34 is in fluid communication with the second water cavity 32 for supplying water from the inlet 1 to the second water cavity 32.

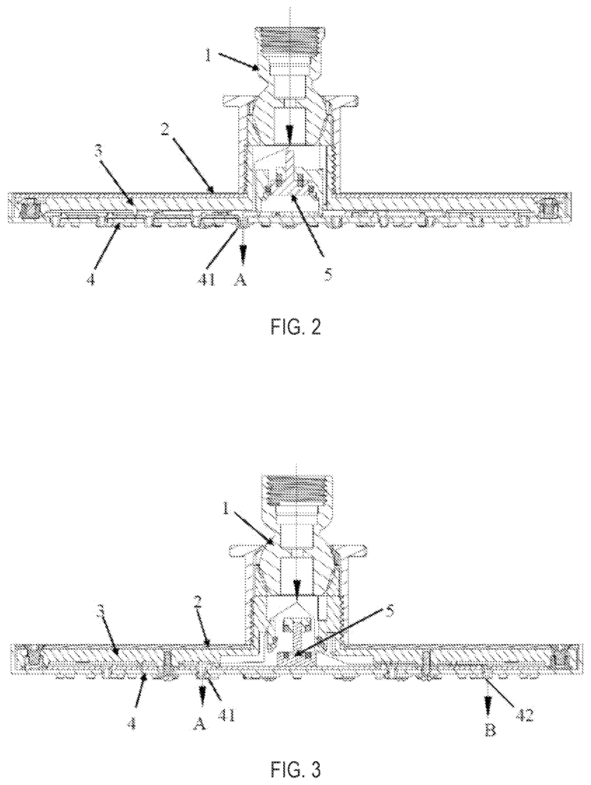

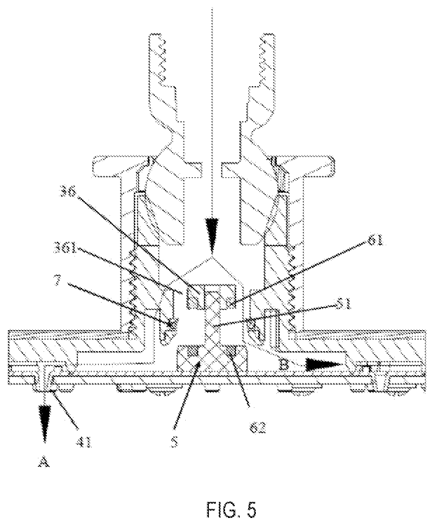

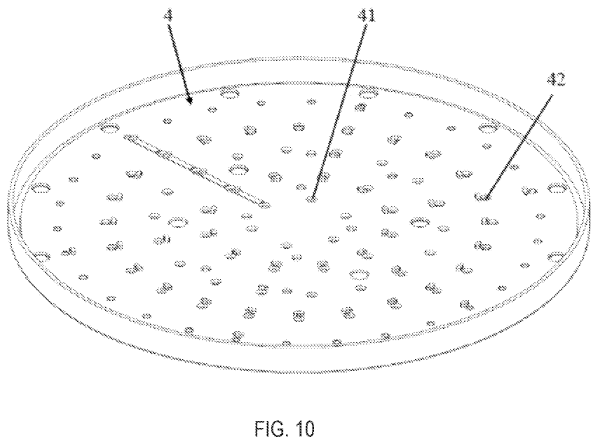

Referring now to FIGS. 2-5 and 10, the lower cover 4 includes at least one first water outlet 41 and at least one second water outlet 42. As utilized herein “first water outlet 41” can refer to one or more (e.g., a plurality) of first outlets and “second water outlet 42” can refer to one or more (e.g., a plurality) of second outlets. The first water outlet 41 can fluidly couple to the first water cavity 31 and the second water outlet 42 can fluidly couple to the second water cavity 32. Accordingly, when water enters the first water inlet channel 33, the water may enter the first water cavity 31 and be sprayed out through the first water outlet 41. When water enters the second water inlet channel 34, the water may enter the second water cavity 32 and be sprayed out through the second water outlet 42. Referring briefly to FIG. 9, the second water inlet channel 34 is fluidly coupled to the second water cavity 32 through a communication channel 35 of the showerhead. As described herein, the second water inlet channel 34 can receive water from a water inlet 361 and the communication channel 35 disposed between each first water cavity 31 can route water to the second water cavity 32.

The lower cover 4 can include any amount of first water outlets 41 and/or second water outlets 42. For example, the lower cover 4 can include a first amount of first water outlets 41 and a second amount of second water outlets 42. In an exemplary embodiment, the first amount of first water outlets 41 is less than the second amount of second water outlets 42 (e.g., the showerhead includes more second water outlets 42 than first water outlets 41). In some exemplary embodiments, the first amount of first water outlets 41 is greater than the second amount of second water outlets 42 (e.g., the showerhead includes less second water outlets 42 than first water outlets 41). In some exemplary embodiments, the first amount of first water outlets 41 is equal to the second amount of second water outlets 42 (e.g., the showerhead includes the same amount of second water outlets 42 as first water outlets 41).

Referring now to FIGS. 2-5 and 11, the showerhead includes a bracket 36 coupled to the showerhead between the upper cover 2 and the lower cover 4. For example, the bracket 36 can be coupled (e.g., mounted) in the second water inlet channel 34 at a top portion of the second water inlet channel 34. The bracket 36 can be or can include various components having one or more apertures that define one or more fluid channels or other portions within the showerhead. For example, the bracket 36 can include a guide hole 362 that can receive a portion of a plug 5 of the showerhead. As another example, the bracket 36 can include or can define a water inlet 361 that fluidly couples to the second water inlet channel 34.

The plug 5 can movably couple to the bracket 36 via the guide hole 362, as shown in FIGS. 2 and 3, such that the plug 5 can slide up and down relative to the bracket 36. By sliding up or down, the plug 5 is capable of controlling (e.g., opening and closing) the second water inlet channel 34 by blocking or unblocking the water inlet 361. For example, the plug 5 can slide between an initial position (e.g., a closed position), as shown in FIG. 2, and an open position, as shown in FIG. 3.

Referring briefly to FIGS. 7-9 and 11, the plug 5 includes or is coupled to a sliding rod 51. The guide hole 362 of the bracket 36 can include a diameter that is about equal to or slightly greater than a diameter of the sliding rod 51 such that the guide hole 362 can receive the sliding rod 51 with a clearance fit. Accordingly, the guide hole 362 can provide stability for the plug 5 during sliding (e.g., allow the sliding rod 51 to move up or down in a controlled manner, prohibit the plug 5 to move in more than one direction, etc.).

The second water inlet channel 34 and/or the plug 5 can include a sealing ring 7. The sealing ring 7 can be or can include various types of sealing rings including, but not limited to, an O-ring. When the plug 5 is in the initial position (the closed position), the sealing ring 7 is sealed between the plug 5 and a side wall of the second water inlet channel 34, sealing the second water inlet channel 34 from the water inlet 361. When the plug 5 is in the open position, the plug 5 is withdrawn from the sealing ring 7 in the second water inlet channel 34 or the plug 5 moves with the sealing ring 7 to unseal the water inlet 361 such that the second water inlet channel 34 is opened, and water may flow through the second water inlet channel 34.

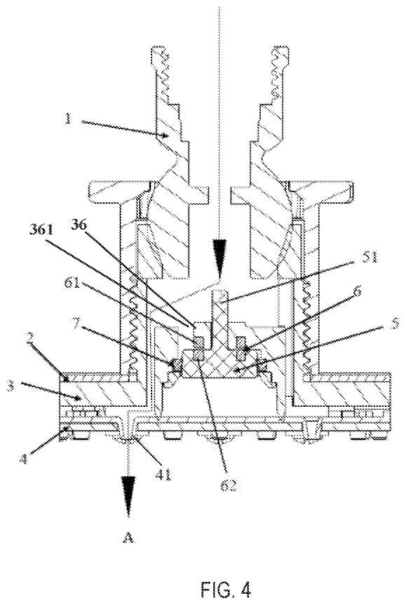

For example, referring to FIGS. 2-5, in the initial position shown in FIGS. 2 and 4, the plug 5 engages with (e.g., contacts, abuts, etc.) the bracket 36 to at least partially block (e.g., seal, occlude) the water inlet 361, so that the second water inlet channel 34 is closed and water cannot flow through the second water inlet channel 34. For example, the plug 5 causes the water inlet 361 to close such that water entering the showerhead inlet 1 flows only through the first water inlet channel 33 positioned along a side portion of the bracket 36.

Referring to FIGS. 4, 5, and 11, the showerhead can include at least one reset mechanism 6 (e.g., a biasing mechanism) that biases the plug 5 towards the initial position. For example, the reset mechanism 6 can include one or more magnets coupled to a portion of the bracket 36 and one or more corresponding magnets coupled to a portion of the plug 5. For example, the reset mechanism 6 can include at least one first magnet 61 and at least one second magnet 62 capable of attracting the first magnet 61. In an exemplary embodiment, the first magnet 61 is mounted on the bracket 36 and the second magnet 62 is mounted on the plug 5. In some exemplary embodiments, the first magnet 61 or second magnet 62 can couple to various other portions of the showerhead, such an interior wall of the showerhead.

In an exemplary embodiment, the first magnet 61 and the second magnet 62 have opposite magnetism such that the magnets attract each other. For example, the first magnet 61 and the second magnet 62 may be arranged with the north pole of one magnet facing the south pole of the other magnet such that the magnets attract each other. The first magnet 61 is mounted on a bottom portion of the bracket 36, and the second magnet 62 is mounted on a top portion of the plug 5 such that the magnets interface with one another (e.g., oppose one another within the showerhead). Accordingly, when the water pressure exerted on the plug 5 and the gravity (e.g., the weight) of the plug 5 are greater than an attracting force between the first magnet 61 and the second magnet 62, the plug 5 moves downwardly to the open position. When the water pressure exerted on the plug 5 and the gravity of the plug 5 are smaller than the attracting force between the first magnet 61 and the second magnet 62, the plug 5 moves upwardly to reset to the initial, closed position.

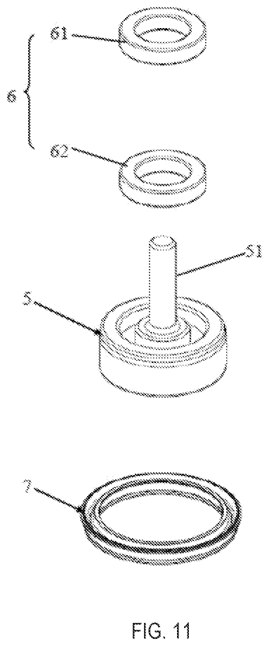

In one exemplary embodiment, as shown in FIG. 11, the first magnet 61 and the second magnet 62 are both annular, with a large acting area and a good mutual attraction effect. In some exemplary embodiments, the magnets can include various other shapes including, but not limited to, rectangular, triangular, or another shape. In some exemplary embodiments, the first magnet 61 can differ in size or shape from the second magnet 62. In some exemplary embodiments, the reset mechanism 6 can include one or more biasing members (e.g., a spring such as a coil spring or leaf spring) coupled to the showerhead that biases the plug 5 towards the closed position. For example, the showerhead can include a spring coupled to the plug 5 and/or to the lower cover 4 that biases the plug 5 to the closed position.

The reset mechanism 6 can bias the plug 5 to the closed position when the water pressure at the plug 5 is between zero (e.g., no pressure) and a threshold temperature value. For example, the reset mechanism 6 can bias the plug 5 to the closed position when the pressure of water at the plug 5 is less than or equal to about 110 kPa. This example is for illustrative purposes only. The reset mechanism 6 can bias the plug 5 to the close position when the pressure of water at the plug 5 is significantly greater or significantly lesser than 110 kPa (e.g., in a range of 0 kPa to 1 MPa).

When the water pressure exerted on the plug 5 is greater than the threshold pressure value, the water pressure and the gravity of the plug 5 overcome an acting force of the reset mechanism 6 and a related friction force such that the plug 5 moves downwardly to be withdrawn from the bracket 36, and the water inlet 361 is opened. If the water pressure exerted on the plug 5 falls below the threshold pressure value, the reset mechanism 6 overcomes the gravity and the related friction force of the plug 5 to move the plug 5 upwardly and block the water inlet 361.

Accordingly, when the water pressure is low, the plug 5 can maintain in the initial, closed position such that the second water inlet channel 34 is closed and water entering from the inlet 1 enters the first water cavity 31 through the first water inlet channel 33 and is sprayed out only through the first water outlet 41, which can increase the impact force of water, as opposed to water spraying out of both the first water outlet 41 and the second water outlet 42. A flowing path of water in this instance is indicated by an arrow A in FIG. 2.

When the water pressure is high, under an action of the water pressure, the pressure of water can overcome the reset mechanism 6 and cause the plug 5 to move downwardly away from the bracket 36 and separated from the water inlet 361, thus opening (e.g., unblocking) the water inlet 361. When the plug 5 is in the open position, the second water inlet channel 34 is opened and water can flow through the second water inlet channel 34. For example, the water pressure can cause the plug 5 to open the second water inlet channel 34 such that at least a portion of water entering from the inlet 1 enters the first water cavity 31 through the first water inlet channel 33 and is sprayed out through the first water outlet 41 and at least a portion of water entering from the inlet 1 enters the second water cavity 32 through the second water inlet channel 34 and is sprayed out through the second water outlet 42, which increases a water spraying range of the shower to meet the impact force of water spraying, as opposed to water only spraying out of the first water outlet 41. A flowing path of water in this instance is indicated by an arrow A and an arrow B in FIG. 3. In one exemplary embodiment, when the plug 5 is at the open position, water can flow through both the first water inlet channel 33 and the second water inlet channel 34. In some exemplary embodiments, when the plug 5 is at the open position, water may flow through only the second water inlet channel 34.

This provides various improvements over existing showerheads, as adjusting the location and number of outlets that expel water according to the water pressure allows for a user to experience a desired impact force of water even at a low water pressure. For example, when the water pressure at the plug 5 is low, the plug 5 can cause the water to flow only through only a first set of outlets (e.g., first water outlet 41) positioned near the inlet 1 to employ the water pressure at a small amount of outlets positioned near the inlet 1. When the water pressure at the plug 5 is higher, the plug 5 can cause the water to flow through both the first set of outlets and a second set of outlets (e.g., second water outlet 42) that are spaced further away from the inlet 1 than the first set of water outlets to more evenly distribute water at a similar water pressure experience for a user.

In one exemplary embodiment, as shown in FIGS. 2-3, 6, and 9-10, the second water cavity 32 is located outside the first water cavity 31 along a radial direction of the middle plate 3 (e.g., such that the second water cavity 32 is disposed further from the inlet 1 than the first water cavity 31), the first water inlet channel 33 is located outside the second water inlet channel 34, and the second water outlet 42 is located outside the first water outlet 41. In this configuration, water received by the inlet 1 travels a further distance to the second water outlet 42 than to the first water outlet 41. By such arrangement, the first water outlet 41 is located in a central area of the lower cover 4, and the second water outlet 42 is located around the first water outlet 41

In one exemplary embodiment, as shown in FIG. 9 and described herein, two first water cavities 31 are symmetrically distributed on the middle plate 3 and the second water cavity 32 surrounds the outside of the two first water cavities 31. The communication channel 35 is located between the two first water cavities 31. The two first water cavities 31 may be communicated or independent of each other. An area on the lower cover 4 corresponding to each first water cavity 31 is provided with the first water outlet 41, and each first water cavity 31 is communicated with the inlet 1 through one first water inlet channel 33.

The specific implementations of the present disclosure are further described hereinafter with reference to the drawings. The same parts are denoted by the same reference numerals. It should be noted that the terms “front”, “back”, “left”, “right”, “up”, and “down” used in the following description refer to the directions in the drawings, and the terms “inner” and “outer” refer to the directions toward or far away from geometric centers of specific parts respectively.

As utilized herein with respect to numerical ranges, the terms “approximately,” “about,” “substantially,” and similar terms generally mean +/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. For example, the bracket of the exemplary embodiment described with reference to FIGS. 2-5 and 11 may be incorporated in another portion of the showerhead. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A showerhead, comprising:
an upper cover, a lower cover, and a middle plate disposed between the upper cover and the lower cover;
wherein a bottom portion of the middle plate defines a first water cavity and a second water cavity that is independent from the first water cavity;
wherein the middle plate defines a first water inlet channel in fluid communication with the first water cavity and a second water inlet channel in fluid communication with the second water cavity;
wherein the lower cover includes a first water outlet in fluid communication with the first water cavity and a second water outlet in fluid communication with the second water cavity; and
wherein the second water inlet channel includes a plug configured to open and close the second water inlet channel responsive to water pressure exerted on the plug within the showerhead.

2. The showerhead according to claim 1, wherein:
when the plug closes the second water inlet channel, water is configured to discharge from the first water outlet; and
when the plug opens the second water inlet channel, water is configured to discharge from both the first water outlet and the second water outlet.

3. The showerhead according to claim 1, further comprising:
a bracket disposed in the second water inlet channel, the bracket having a water inlet;
wherein the plug is slidably configured in the second water inlet channel;
wherein, when the plug is in an initial state, the plug is engaged with the bracket and blocks the water inlet;
wherein, when the plug is in an open state, the plug is separated from the bracket and withdrawn from the water inlet; and
the plug is coupled to a reset mechanism configured to bias the plug towards the initial state.

4. The showerhead according to claim 3, wherein:
the reset mechanism comprises a first magnet coupled to the bracket and a second magnet coupled to the plug; and
the second magnet is configured to attract the first magnet.

5. The showerhead according to claim 4, wherein the first magnet and the second magnet are both annular.

6. The showerhead according to claim 3, wherein the reset mechanism includes a spring coupled to the plug and configured to bias the plug towards the initial state.

7. The showerhead according to claim 3, wherein,
when the water pressure exerted on the plug is greater than or equal to a threshold pressure value, the plug is configured to slide to open the water inlet; and
when the water pressure exerted on the plug is less than the threshold pressure value, the plug is configured to slide to block the water inlet via the reset mechanism.

8. The showerhead according to claim 3, wherein:
the plug includes a sliding rod; and
the bracket includes a guide hole to receive the sliding rod.

9. The showerhead according to claim 8, wherein a diameter of the guide hole is greater than or equal to a diameter of the sliding rod.

10. The showerhead according to claim 1, wherein the second water cavity is located outside the first water cavity along a radial direction of the middle plate.

11. The showerhead according to claim 1, wherein the first water inlet channel is located outside the second water inlet channel along a radial direction of the middle plate.

12. The showerhead according to claim 1, wherein the first water outlet is located outside the second water outlet along a radial direction of the middle plate.

13. The showerhead according to claim 1, wherein the second water inlet channel is fluidly coupled to the second water cavity by a communication channel.

14. The showerhead according to claim 10, wherein:
the middle plate includes two first water cavities symmetrically positioned on the middle plate; and
the second water cavity surrounds the outside of the two first water cavities.

15. The showerhead according to claim 1, wherein the plug includes a radial seal.

16. The showerhead according to claim 1, wherein the second water inlet channel includes a radial seal.

17. The showerhead according to claim 1, wherein the lower cover includes a plurality of first water outlets in fluid communication with the first water cavity and a plurality of second water outlets in fluid communication with the second water cavity.

18. The showerhead according to claim 17, wherein an amount of the plurality of first water outlets is less than an amount of the plurality of second water outlets.

19. The showerhead according to claim 1, wherein the middle plate includes a separating rib between the first water cavity and the second water cavity.

20. A method, comprising:
providing a showerhead, the showerhead including:
an upper cover, a lower cover, and a middle plate disposed between the upper cover and the lower cover;
wherein a bottom portion of the middle plate defines a first water cavity and a second water cavity that is independent from the first water cavity;
wherein the middle plate defines a first water inlet channel in fluid communication with the first water cavity and a second water inlet channel in fluid communication with the second water cavity;
wherein the lower cover includes a first water outlet in fluid communication with the first water cavity and a second water outlet in fluid communication with the second water cavity; and
wherein the second water inlet channel includes a plug configured to open and close the second water inlet channel responsive to water pressure exerted on the plug within the showerhead.
